(19) United States
(12) Patent Application Publication
(10) Pub. No.: US 2007/0121475 A1
(43) Pub. Date: May 31, 2007

(54) Method and system for controlling the level of a data signal read from an optical disc

(75) Inventor: Rob Otte, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/581,644

(22) PCT Filed: Nov. 30, 2004
(86) PCT No.: PCT/IB04/03924

§ 371 Date: Jun. 5, 2006

(30) Foreign Application Priority Data
Dec. 8, 2003 (EP) 03300245.2

(51) Int. Cl. G11B 7/00

(52) U.S. Cl. 369/124.11

(57) ABSTRACT

The invention relates to a method of controlling the level of an input readout signal read from an optical disc. The method proposes to use an amplification step for amplifying the input readout signal by an adjustable gain factor for generating an amplified output readout signal having an amplitude in the range [I min target, I max target]. The value of this gain is derived from a feedback loop control in charge of comparing the level of the output readout signal with that of target levels I min target and I max target, and deriving a gain value taking into account the level of the input readout signal. This loop control renders it possible to clamp the input readout signal, counteracting as a consequence the decrease of the input readout signal in the case of a reflectivity reduction of the optical disc. Use: Optical disc reader.

### FIELD OF THE INVENTION

The present invention relates to a method and system for controlling the level of a data signal read from an optical disc.

The present invention also relates to a method of generating an information signal intended to indicate the presence of a defect at the surface of an optical disc.

This invention has many applications in the field of optical recording.

### BACKGROUND OF THE INVENTION

In optical recording systems such as CD, DVD, or Blue Ray (BD) disc, the information recorded on the optical disc is retrieved from a readout signal, conventionally represented by an eye pattern as illustrated in FIG. 1. Information is often retrieved from a processing chain including a photo detector, a bit detection system, a preamplifier, a gain and level control, an equalizer, a timing recovery system, and an error correction system.

Data information is recorded on the disc, for example, as a series of pits and lands representing binary data and forming a track. A laser spot remains locked to the track for scanning-by the pit-land relief structure. The reflected light spot is incident on the photo-detector. The regions between the impressed pits reflect the incident light without interference, and hence the corresponding readout signal derived from the photo detector reaches maximum values. Conversely, a minimum level of the readout signal corresponds to light which has been strongly reduced by interference while reflected by a pit. The readout signal as depicted in FIG. 1, referenced by the dark level (DL), is thus spatially modulated by the pits and lands, which are integer multiples of the channel bits.

For ensuring a robust reading of the data stored on the disc, it is required to generate a readout signal that varies between a low target level I_min_target and a high target level I_max_target, these targets levels being known from specifications or from a measurement.

Gain and level control serve to shift the readout signal into an appropriate range, in particular by counteracting level variations caused by a reduction of the disc reflectivity caused by a defect of the disc, such as a fingerprint, a scratch, or a dark speck.

Known gain and level control systems are based on combinations of peak detection and time constants. In such systems, gain is increased until a predefined peak level is exceeded. When this happens, gain is decreased again. A similar approach is used for level control. The gain and level adaptation is commonly performed with the use of a time constant. When the time constant is large, the system response is slow but accurate in the nominal situation, as the gain and level control signals are usually not very noisy. On the other hand, a slow response prevents the system from quickly responding to defects. If the time constant is reduced, the system becomes jittery, thus degrading the performance which is measured in terms of jitter and error rate. The optimum setting is dependent on many parameters in the drive and the disc, and usually determined by trial and error.

This known method has its limitations in that the optimal time constant is difficult to define, considering that it should be great to prevent baseline wander, but small to effectively remove undesired low-frequency variations caused by disc defects.

### OBJECT AND SUMMARY OF THE INVENTION

It is an object of the invention to propose an improved method of controlling the level of an input readout signal read from an optical disc.

To this end, the method according to the invention proposes to use an amplification step for amplifying the input readout signal-by-an-adjustable gain factor for generating an amplified output readout signal having an amplitude in the range [I_min_target, I_max_target]. The value of this gain is derived from a feedback loop control in charge of comparing the level of the output readout signal with that of target levels I_min_target and I_max_target, and deriving a gain value taking into account the level of the input readout signal. This loop control renders it possible to clamp the input readout signal, counteracting as a consequence the decrease of the input readout signal in the case of a reflectivity reduction of the optical disc.

The method is based on the fact that the outer levels of the input readout signal reduce in a similar way with respect to the dark level, because the reflectivity of pit and land is degraded in equal measure by the aforementioned defects of the optical disc. Thus, there is only one parameter to adjust, this parameter being the gain with respect to the dark level.

This method is also relevant in that the level control is independent of the frequency content of the readout signal, because the control is only based on amplitude information.

It is also an object of the invention to propose a control system for controlling the level of an input readout signal, said control system comprising means for implementing the different steps of the above-mentioned method according to the invention.

In the case of a major defect, such as a dark speck or a deep scratch, the reflectivity of the laser beam is strongly reduced. As a consequence, the input readout signal is of low amplitude and very noisy, so that it may be assumed that, even if the gain is set to a very high value, data recovery is in this case nearly impossible.

An additional step is thus advantageously added to the above-mentioned method according to the invention. This additional step consists in generating a signal that is intended to assume a first state if said gain is below a gain threshold and a second state if said gain is above said gain threshold.

This information signal is used for indicating the presence of a defect at the surface of an optical disc that results in a reflectivity reduction. This information signal may be used, for example, to improve the reading strategy of the optical disc, for example in jumping the area considered as comprising a defect.

Detailed explanations and other aspects of the invention will be given below.

### BRIEF DESCRIPTION OF THE DRAWINGS

The particular aspects of the invention will now be explained with reference to the embodiments described hereinafter and considered in connection with the accompanying drawings, in which identical parts or sub-steps are designated in the same manner:

FIG. 1 illustrates the eye pattern of a input readout signal read from an optical disc,

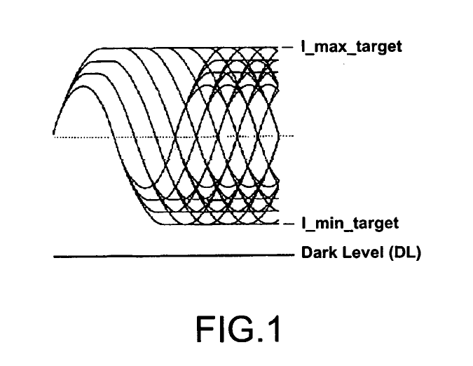

FIG. 2 is a the flowchart of processing steps according to the invention,

FIG. 3 shows an embodiment of a control system according to the invention, and

FIG. 4 illustrates an example of the method according to the invention.

### DETAILED DESCRIPTION OF THE INVENTION

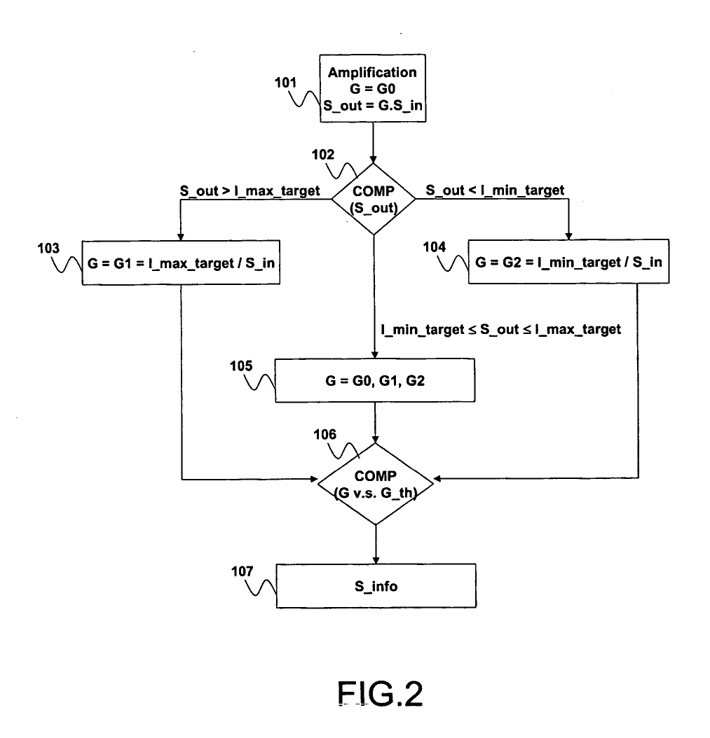

FIG. 2 is a flowchart of processing steps for controlling the level of an input readout signal S_in read from an optical disc for generating an output readout signal S_out.

This method comprises a step 101 of amplifying the input readout signal S_in by a gain G for generating the output readout signal S_out. Readout signals are thus linked by the following relation:
S_out=G*S_{—in} Eq.1
The gain G is initially set to an arbitrary value G0, for example G0=1.

This method comprises a step 102 of comparing said output readout signal S_out with a maximum target level I_max_target and with a minimum target level I_min_target. The target levels are known, for example, from specifications, or chosen by measurement so as to be close to the maximum and minimum levels of the input readout signal S_in in optimal conditions (i.e. without reduction of the laser beam reflected from the optical disc).

This method comprises a first step 103 of setting said gain G to a value G1 defined as the ratio between said maximum target level I_max_target and the level of said input readout signal S_in if the level of said output readout signal S_out exceeds said maximum target level I_max_target. This step 103 is summarized by the following first rule:

| | |
|---|---|
| if S_out > I_max_target, | |
| then G = G1 = I_max_target / S_in | Eq.2 |

By setting the gain G to a particular value G1, the step 103 results in a clipping of the readout signal to I_max_target. Consequently, the readout signal is brought to within the range [I_min_target, I_max_target].

This method comprises a second step 104 of setting said gain G2 to a value defined as the ratio between said minimum target level I_min_target and the level of said input readout signal S_in if the level of said output readout signal S_out drops below said minimum target level I_min_target. This step 104 is summarized by the following second rule:

| | |
|---|---|
| if S_out < I_min_target, | |
| then G = G2 = I_min_target / S_in | Eq.3 |

By setting the gain G to a particular value G2, the step 104 results in a clipping of the readout signal to I_min_target. Consequently, the readout signal is brought to within the range [I_min_target, I_max_target].

This method comprises a third step 105 of setting said gain G to the value as previously set by said first and second steps 103 and 104, if the level of said output readout signal S_out does not exceed said maximum target level I_max_target nor drops below said minimum target level I_min_target. In other words, if the output readout signal S_out remains in the range [I_min_target, I_max target], the gain G is not changed, and it will remain either equal to the initial gain value G0, or to the gain value G1 defined by the first rule, or to the gain value G2 defined by the second rule.

Note that the procedure according to the invention of bringing the readout signal to within the range [I_min_target, I_max_target] can be executed continuously and possibly instantaneously in order to track the variations in playback conditions (i.e. reflectivity changes).

The processing steps 102-103-104-105 can be the basis for defining a method of generating an information signal S_info indicating a defect of an optical disc. This method of generating an information signal is based on a variation analysis of the gain value G.

To this end, this method of generating an information signal S_info comprises a step 106 of comparing said gain G with a gain threshold G_th, and a step 107 of generating said information signal having a first state s1 if said gain G is below said gain threshold G_th and a second state s2 if said gain G is above said gain threshold G_th.

The input readout signal can be considered as the sum of a data signal and a noise signal of constant amplitude. If the input readout signal S_in is very low, i.e. mainly comprising a noise signal, a gain G having a high value is derived from step 103. Since it makes no sense to amplify an input readout signal S_in that mainly comprises a noise signal, because detection of data is impossible in this case, the gain threshold G_th may be defined as the ratio I_min_target/σ, where σ corresponds to a measure of the noise level in the input readout signal S_in.

This information signal S_info may be used, for example, to improve the reading strategy of the optical disc, for example in jumping the area considered as comprising a defect.

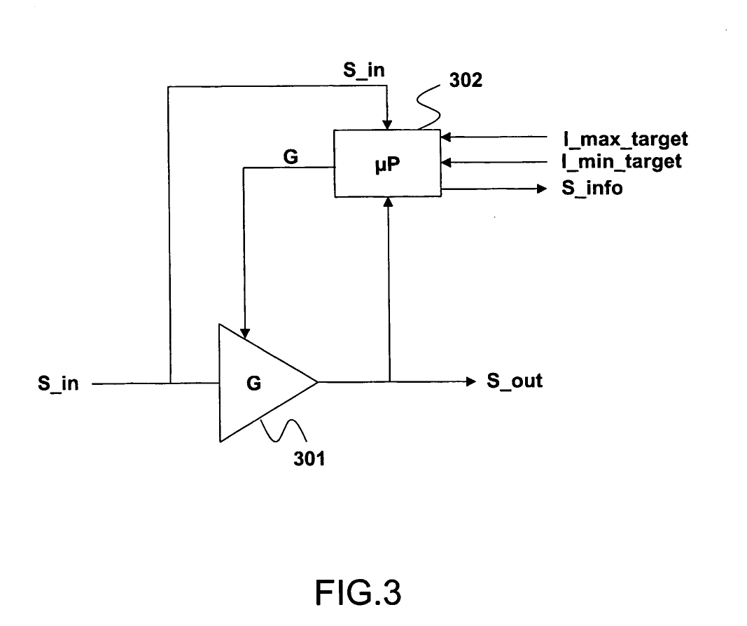

FIG. 3 represents an embodiment of a control system according to the invention for controlling the level of an input readout signal S_in read from an optical disc for generating an output readout signal S_out, said system comprising:
means 301 for amplifying said input readout signal S_in by a gain factor G for generating said output readout signal S_out,
means 302 for comparing said output readout signal S_out with a maximum target level I_max_target and with a minimum target level I_min_target,
means 302 for setting said gain G to a value defined as the ratio between said maximum target level I_max_target and the level of said input readout signal S_in if the level of said output readout signal S_out exceeds said maximum target level I_max_target,
means 302 for setting said gain G to a value defined as the ratio between said minimum target level I_min_target and the level of said input readout signal S_in if the level of said output readout signal S_out drops below said minimum target level I_min_target,
means 302 for setting said gain G to the value as previously set by said first and second means 302, if the level of said output readout signal S_out does not exceed said maximum target level I_max_target nor drops below said minimum target level I_min_target.

The processing may be performed in the digital domain. Means 302 correspond to a signal processor executing code instructions stored in a memory device (not shown). These code instructions carry out the functions of the steps 102-103-104-105 as described above, taking into account the values of input parameters I_min_target and I_max_target, for example stored in said memory device. Analog-to-digital converters (not shown) are used for sending digital values of the input readout signal S_in and the output readout signal S_out to the processing means 302.

The means 301 may also be constituted by a signal processor, or alternatively by a conventional amplifier using a transistor-based structure. In the latter case, the gain defined by means 302 is buffered in an input digital register, then converted in the analogue domain by a digital-to-analog converter (not shown) for varying some gain parameters of the amplification means 301 (e.g. the charge of a capacitor by a current proportional to the analog gain value).

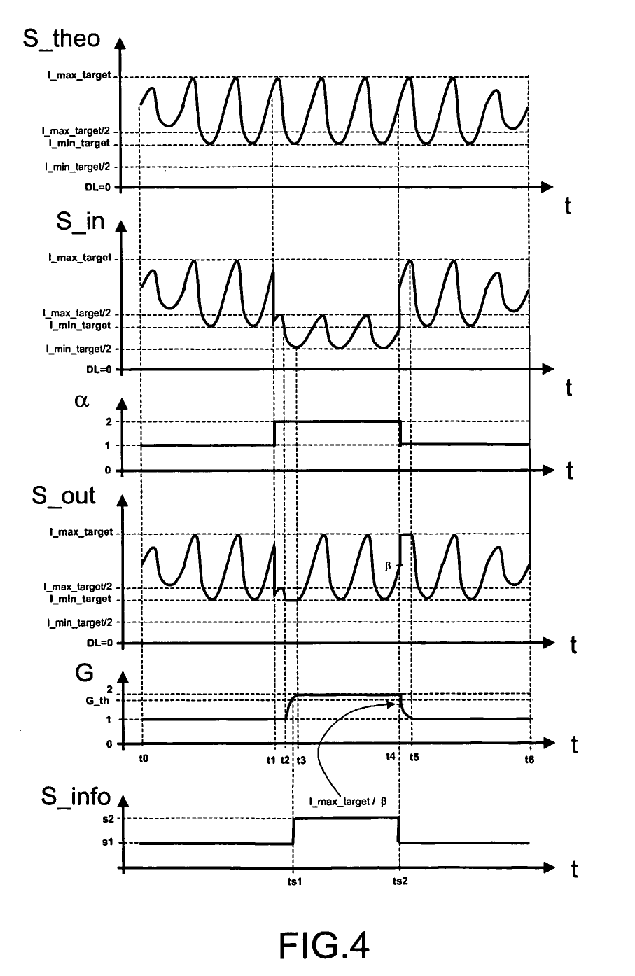

FIG. 4 shows an example of the level control performed by the method according to the invention. In this figure:
signal S_theo corresponds to the variation in time of the theoretical readout signal that should be derived from the reading of the optical disc, without reflectivity reduction. This signal varies in the range [I_min_target, I_max_target].
S_in corresponds to the variation in time of the experimental input readout signal derived from a photodetector when the optical disc is read, for example a four-quadrant detector embedded in a reader apparatus intended to read the optical disc,
α corresponds to the variation in time of the reflectivity attenuation caused by the defect of the optical disc, the attenuation being caused, for example, by a scratch, a fingerprint, or a dark speck at the surface of the optical disc. This attenuation is of course not known to the system control.
S_out corresponds to the variation in time of the output readout signal after being passed through the control system according to the invention,
G corresponds to the variation in time of the amplification gain applied to the input readout signal S_in for generating the output readout signal S_out.

In the time range [t0, t1], the reflection of the laser beam applied to the optical disc is not reduced since no defects are present at the surface of the optical disc. The input readout signal S_in is in the range [I_min_target, I_max_target], and the gain G is set, for example, to an initial default value equal to 1. The output readout signal S_out is identical to the input readout signal S_in.

In the time range [t1, t2], the reflection of the laser beam applied to the optical disc is attenuated by a factor 2 because of some defects present at the surface of the optical disc. The input readout signal S_in immediately decreases by a factor 2, but still remains in the range [I_min_target, I_max_target], so that the gain G remains equal to 1. The output readout signal S_out is identical to the input readout signal S_in.

In the time range [t2, t3], the reflection of the laser beam applied to the optical disc is still attenuated by a factor 2. The input readout signal S_in now drops below I_min_target until reaching I_min_target/2. The output readout signal S_out also tends to drop below I_min_target, but S_out is immediately corrected by the control system increasing the gain G according to Eq.3. The gain G increases until reaching a value of 2. The signal S_out is thus clipped to I_min^{—}target.

In the time range [t3, t4], the reflection of the laser beam applied to the optical disc is still attenuated by a factor 2. The input readout signal S_in now starts increasing above I_min_target/2. With a gain previously set to 2, the output readout signal S_out now tends to exceed I_min_target, so that S_out is still in the range [I_min_target, I_max_target]. As a consequence, the gain G applied to signal S_in remains set to the previous value defined at time t3 according to Eq.3. The signal S_out is identical to the theoretical data signal S_theo, which means that the reduction of the laser beam reflectivity is compensated by the control system according to the invention.

In the time range [t4, t5], the optical disc has no more defects on its surface. The laser beam is thus no longer attenuated so that the attenuation gain α goes down to 1. The input readout signal S_in is now identical to signal S_theo. With a gain previously set to 2, the output readout signal S_out now tends to exceed I_max_target, so that S_out is immediately corrected by the control system decreasing the gain G according to Eq.2. The gain G decreases until reaching a value of 1. The signal S_out is thus clipped to I_max_target.

In the time range [t5, t6], the input readout signal S_in starts decreasing below I_max_target. With a gain previously set to 1, the output readout signal S_out now tends to drop below I_max_target, so that S_out is in the range [I_min_target, I_max_target]. As a consequence, the gain G applied to signal S_in remains set to the previous value defined at time t5 according to Eq.2. The signal S_out is thus identical to the input readout signal S_in and to the theoretical data signal S_theo.

It is noted that the readout signal in the time range [t1, t2] cannot be recovered since the input readout signal S_in is still in the range [I_min_target, I_max_target], which is considered as a correct range, as well in the time ranges [t2, t3] and [t4, t5] since the output readout signal S_out is clipped to I_min_target and I_max_target, respectively.

In the time range [t0, ts1], the gain G is below the gain threshold G_th, so that the information signal S_info has a first state s1.

In the time range [ts1, ts2], the gain G is above the gain threshold G_th, so that the information signal S_info has a second state s2.

In the time range [ts2, t6], the gain G is below the gain threshold G_th, so that the information signal S_info has the first state s1.

The control system according to the invention can advantageously be implemented in an apparatus for reading data stored on an optical disc.

Use of the verb “comprise” and its conjugations does not exclude the presence of elements or steps other than those stated in the claims. Use of the article “a” or “an” preceding an element or step does not exclude the presence of a plurality of such elements or steps.

1. Method of controlling the level of an input readout signal (S_in) read from an optical disc for generating an output readout signal (S_out), said method comprising:
a step (101) of amplifying said input readout signal (S_in) by a gain factor (G) for generating said output readout signal (S_out),
a step (102) of comparing said output readout signal (S_out) with a maximum target level (I_max_target) and with a minimum target level (I_min_target),
a first step (103) of setting said gain factor (G) to a value defined as the ratio between said maximum target level (I_max_target) and the level of said input readout signal (S_in) if the level of said output readout signal (S_out) exceeds said maximum target level (I_max_target),
a second step (104) of setting said gain factor (G) to a value defined as the ratio between said minimum target level (I_min_target) and the level of said input readout signal (S_in) if the level of said output readout signal (S_out) drops below said minimum target level (I_min_target),
a third step (105) of setting said gain factor (G) to the value as previously set by said first and second steps (103, 104) if the level of said output readout signal (S_out) does not exceed said maximum target level (I_max_target) nor drops below said minimum target level (I_min_target).

2. Method of generating an information signal indicating a defect of an optical disc, said method comprising:
a step (101) of amplifying an input readout signal (S_in) by a gain factor (G) for generating an output readout signal (S_out),
a step (102) of comparing said output readout signal (S_out) with a maximum target level (I_max_target) and with a minimum target level (I_min_target),
a first step (103) of setting said gain factor (G) to a value defined as the ratio between said maximum target level (I_max_target) and the level of said input readout signal (S_in) if the level of said output readout signal (S_out) exceeds said maximum target level (I_max_target),
a second step (104) of setting said gain factor (G) to a value defined as the ratio between said minimum target level (I_min_target) and the level of said input readout signal (S_in) if the level of said output readout signal (S_out) drops below said minimum target level (I_min_target),
a third step (105) of setting said gain factor (G) to the value as previously set by said first and second steps (103, 104) if the level of said output readout signal (S_out) does not exceed said maximum target level (I_max_target) nor drops below said minimum target level (I_min_target),
a step (106) of comparing said gain factor (G) with a gain threshold (G_th),
a step (107) of generating said information signal having a first state (s1) if said gain factor (G) is below said gain threshold (G_th), and a second state (s2) if said gain factor (G) is above said gain threshold (G_th).

3. System for controlling the level of an input readout signal (S_in) read from an optical disc for generating an output readout signal (S_out), said system comprising:
means (101) for amplifying said input readout signal (S_in) by a gain factor (G) for generating said output readout signal (S_out),
means (102) for comparing said output readout signal (S_out) with a maximum target level (I_max_target) and with a minimum target level (I_min_target),
means (103) for setting said gain factor (G) to a value defined as the ratio between said maximum target level (I_max_target) and the level of said input readout signal (S_in) if the level of said output readout signal (S_out) exceeds said maximum target level (I_max_target),
means (104) for setting said gain factor (G) to a value defined as the ratio between said minimum target level (I_min_target) and the level of said input readout signal (S_in) if the level of said output readout signal (S_out) drops below said minimum target level (I_min_target),
means (105) for setting said gain factor (G) to the value as previously set by said first and second means (103, 104) if the level of said output readout signal (S_out) does not exceed said maximum target level (I_max_target) nor drops below said minimum target level (I_min_target).

4. Apparatus for reading an optical disc, said apparatus comprising a system for controlling the level of an input readout signal (S_in) read from said optical disc for generating an output readout signal (S_out), said system comprising:
means (101) for amplifying said input readout signal (S_in) by a gain factor (G) for generating said output readout signal (S_out),
means (102) for comparing said output readout signal (S_out) with a maximum target level (I_max_target) and with a minimum target level (I_min_target),
means (103) for setting said gain factor (G) to a value defined as the ratio between said maximum target level (I_max_target) and the level of said input readout signal (S_in) if the level of said output readout signal (S_out) exceeds said maximum target level (I_max_target),
means (104) for setting said gain factor (G) to a value defined as the ratio between said minimum target level (I_min_target) and the level of said input readout signal (S_in) if the level of said output readout signal (S_out) drops below said minimum target level (I_min_target),
means (105) for setting said gain factor (G) to the value as previously set by said first and second means (103, 104) if the level of said output readout signal (S_out) does not exceed said maximum target level (I_max_target) nor drops below said minimum target level (I_min_target).

5. A computer program comprising code instructions for implementing the steps of the method as claimed in claim 1.
